(19) United States
(12) Patent Application Publication
(10) Pub. No.: US 2002/0140218 A1
(43) Pub. Date: Oct. 3, 2002

(54) One-piece woven airbag

(76) Inventor: Alonzo W. Beasley JR., Easley, SC (US)

Correspondence Address: PENNIE & EDMONDS LLP, 1667 K STREET NW, SUITE 1000, WASHINGTON, DC, 20006

(21) Appl. No.: 09/819,901

(22) Filed: Mar. 29, 2001

(51) Int. Cl. B60R 21/16

(52) U.S. Cl. 280/743.1

(57) ABSTRACT

The airbag according to the invention includes a one-piece woven bag having an upper layer, a lower layer and a joining edge. A coating or laminating layer is associated with the interior side of the upper and lower layers and the joining edge is positioned inside the bag. First and second openings are disposed along a portion of the joining edge of the bag. The first opening is closed and the second opening is associated with an inflator mechanism. In another airbag according to the invention, an opening is provided through the upper and lower layers and the opening is patched closed. A method of manufacturing an airbag includes forming a one piece bag, cutting the bag, turning the bag inside out, and closing the bag. The bag includes an upper layer, a lower layer, and a joining edge for joining the upper and lower layers. In one embodiment, the bag is cut along a portion of the joining edge to separate the upper and lower layers of the bag along a cut portion. The bag is closed through the cut portion. In another embodiment, the bag is cut through the upper and lower layers and patched to close the openings. The bag is turned inside out through the cut portion so that the coated sides of the layers and the joined edge are disposed inside the bag.

### FIELD OF THE INVENTION

This invention relates to a safety apparatus for protecting the head and neck of an occupant of a vehicle. In particular, the invention relates to a method for manufacturing a one-piece woven airbag and to an airbag formed from a one-piece woven fabric. The airbag of the invention is particularly useful as a curtain in rollover or side-impact automotive applications.

### BACKGROUND OF THE INVENTION

Airbag safety restraints have become commonplace in modem vehicles. According to the Insurance Institute for Highway Safety, in January, 2001, over 107 million (52%) of the over 207 million cars and light trucks on U.S. roads have driver-side airbags. Over 81 million (39.4%) of these have passenger airbags. Deaths as a result of frontal crashes have been significantly reduced as a result of airbag use.

More recently, there has become a greater demand for head and upper body protection during side and lateral vehicle collisions in both motor vehicle and aerospace applications, among others. Occupants killed in side impact crashes typically have higher incidences of head, neck and upper body injuries. In addition, with the increase in production and sales of sport utility vehicles (SUVs), it has become apparent to the industry that the stability of these vehicles in crash avoidance situations can be marginal. Existing driver-side, passenger-side, and, more recently, side impact cushions help to prevent or limit injuries, but are not designed to protect the heads of occupants, particularly in the event of a rollover condition or a clear side strike from another vehicle. Therefore, it has become evident that safety mechanisms capable of protecting the head and upper body of occupants are necessary.

In order to protect the head and upper body during rollover conditions, air bag curtains have been designed that are typically installed in the roof or roof supports of automobiles. When a sensor is triggered to activate the airbag curtains, the curtains will expand to at least partially cover parts of the windows of the vehicle, or, in some cases, the entire interior side of the vehicle. Airbags that are designed for rollover protection are different from conventional front and side airbags in that they are designed to remain inflated for a longer period of time, such as seven seconds. This is in contrast to front impact airbags, which are only required to stay inflated for 50 milliseconds to 2 seconds, depending on the application, and preferably lose some air during passenger impact with the bag in order to cushion the blow, rather than allowing the passenger to rebound off the inflated bag. Several automobile manufacturers are currently including rollover airbags in their year 2000 and beyond vehicles.

Several approaches have been taken to airbag design in the past. These approaches have recently been utilized in designing curtains for rollover and side impact protection. One approach involves utilizing coated materials and sewing them into the shape of an elongated bag configuration. An example of such airbags is shown in U.S. Pat. No. 5,073,418 to Thornton et al. and U.S. Pat. No. 6,142,520 to Iino et al. One problem with this type of technology is that the sewing equipment, some of which is programmable, is very expensive, slow and cumbersome due to long cycle times. Another shortcoming is that air can leak through the sewn seams. Because rollover cushions are required to hold air for up to seven seconds, the cushions are required to be sewn with lock stitch seams, which are slow, expensive, and require frequent bobbin replacement. The other objection to this technology is that many of the sewn areas need to be sealed with silicone or other types of adhesive sprays in order to properly seal the bag. This increases the cost and weight of the airbag cushion, and reduces the packability of the bag in its housing. Lighter weight coatings allow for greater packability or foldability for storage purposes.

Another technology involves one piece weaving or woven (OPW) technology. This technology was born in Europe and was developed by a group know at that time as Airbags International (AIL) which was later purchased by Autoliv Development AB of Sweden. Examples of woven air bags that utilize this technology are discussed in U.S. Pat. Nos. 5,685,347 and 5,651,395 to Graham et al. Unfortunately, the technology has not been fully embraced by the automotive industry due to its intensive cost commitment caused by its use ofjacquard weaving, compared to existing sewing technology in low labor cost areas. With the large size of these new rollover cushions or “curtains,” the OPW technology lends itself to a more competitive position versus traditional sewing techniques. Some of these new curtain systems can extend to cover the entire window length of the vehicle. Sewing and sealing using traditional techniques can become quite expensive and labor intensive. One advantage of utilizing OPW technology is that the entire curtain may be designed and woven through a jacquard mechanism which can weave intricate baffles or channels of air flow as described in some Autoliv patents, such as U.S. Pat. No. 5,788,270 to Haland et al. The problem with prior OPW concepts is their inability to hold air for the time period required in rollover situations. The Autoliv OPW designs currently utilize a coating on the exterior surfaces of the cushion in order to meet the seven second time requirement, which requires that the cushion be coated with two to three ounces of silicone rubber on each side of the cushion. This is due to the transition from the plain woven areas of the bag to the seam areas of the bag which are typically woven with a basket or twill, combining or joining the two layers together. This transitional area, which is the main focus as the bag inflates, tends to separate the external coating from the surface of the woven fabric, resulting in leakage at the seams of the bag. Improvement over existing designs is desirable.

### SUMMARY OF THE INVENTION

The present invention relates to an airbag and a method of manufacturing an airbag. The method of manufacturing an airbag includes forming a one-piece woven fabric bag comprising an upper layer, a lower layer, and a joining edge that joins the upper layer to the lower layer. The upper and lower layers have a coating or lamination associated with one side thereof. The one-piece woven bag is cut along at least a portion of the joining edge to separate the upper layer from the lower layer along a cut portion. The bag is turned inside out through the cut portion so that the coated or laminated sides of the upper and lower layers and the joining edge are disposed inside the bag. The cut portion of the bag is then closed.

The method may also include folding over the cut portion of the bag to form a folded over portion and closing the cut portion through the folded over portion. Rivets may be attached to the folded over portion. The bag can be substantially oblong in shape and the joining edge can include a top edge, a bottom edge, and side edges. The method may also include attaching the top edge of the bag to a portion of a vehicle. The folded over portion may be disposed along at least the top edge or the side edge. Alternatively, fasteners may be attached to the folded over portion and the top edge can be attached to a portion of the vehicle via fasteners.

In one embodiment, the bag can be closed at the cut portion by sewing, gluing, welding, or fastening the folded over portion of the bag. The cut portion may include the coated side of the first layer facing the coated side of the second layer and the closing step may include sewing, gluing, welding or fastening the coated side of the first and second layers together.

The joined edge is formed of woven yarns to join the upper layer to the lower layer. The joined edge is formed utilizing woven yarns of at least one of a 2×2 basket weave, a 3×3 basket weave, a gegenschlauch weave, or other transitional weaves, such as twills or satins. The woven fabric may be formed from yarns of at least one of nylon 6, nylon 6.6, polypropylene, or polyester.

In one embodiment of the invention, the method includes connecting the first layer to the second layer at selected locations. The connecting step may include sewing a plurality of seams at the selected locations. The seams may be coated with a material to reduce the permeability of the seams. Alternatively, or in addition thereto, the connecting step may include attaching at least one tether to the upper and lower layers at the selected locations.

The method may also include cutting an opening in the one-piece woven bag for attachment to an inflator mechanism.

Another embodiment of the method of manufacturing an airbag includes forming a sheet of woven fabric having an upper layer of fabric, a lower layer of fabric, and a joining edge that joins the upper layer to the lower layer, applying a coating or lamination to both exterior sides of the sheet to reduce the permeability of the fabric, cutting the fabric into a desired shape, cutting the bag along the joining edge along a cut portion and turning the bag inside out, and closing the cut portion of the bag. The bag is cut into a desired shape through the joining edge of the sheet to form a one-piece woven bag so that the upper and lower layers are joined by the joining edge. The bag is also cut along at least a portion of the joining edge to separate the upper layer from the lower layer along a cut portion. The bag is turned inside out through the cut portion so that the coating and joining edge are disposed inside the bag.

The method may also include folding over the cut portion of the bag to form a folded over portion and closing the cut portion through the folded over portion by sewing through the folded over portion of the bag. The cut portion may include a coated side of the first layer facing a coated side of the second layer and the closing step includes at least one of sewing, welding, gluing, or fastening the coated sides of the first and second layers together.

The desired shape of the bag may be substantially oblong and the joining edge may include a top edge, a bottom edge, and side edges. The method may further include attaching the top edge of the bag to a portion of a vehicle.

The coating step of the method may include applying at least one of silicone rubber, urethane, film, laminate, or adhesive to the sides of the sheet.

The method may also include connecting the first layer to the second layer at selected locations. This may include sewing a plurality of seams at the selected locations and coating the seams with a material to reduce the permeability of the seams. Alternatively, this may include attaching at least one tether to the upper and lower layers at the selected locations.

The airbag of the invention includes a one-piece woven bag having an upper layer, a lower layer, and ajoining edge joining the upper layer to the lower layer. The joining edge is disposed inside the one-piece woven bag. A coating layer is applied to an interior side of the upper and lower layer. The coating layer substantially covers the entire surface area of the interior sides of the bag. A first opening is disposed along a portion of the joining edge of the one-piece woven bag and the opening is closed. At least one second opening is disposed along a portion of the joining edge of the one-piece woven bag and the second opening is for association with an inflator mechanism.

The first opening of the airbag may be folded over to form a folded over portion and is closed through a treatment applied to the folded over portion. This treatment may include welding, sewing, gluing or fastening the opening closed. Alternatively, the first opening may include the coating of the first layer facing the coating of the second layer and the first opening is sewn, welded, glued or fastened closed. The airbag may also include a plurality of seams sewn through the upper and lower layer of the bag to form baffles. Alternatively, or in addition thereto, at least one tether may be secured between the upper and lower layers in order to join the layers inside the bag. The at least one tether includes a first end and a second end, and the first end is connected to the upper layer while the second end is connected to the lower layer. The first end of the tether may be sewn to the upper layer and the second end of the tether may be sewn to the lower layer. Woven baffle sections may, alternatively, or in addition thereto, be formed between the upper and lower layers of the one-piece woven bag to form baffles. The airbag may be a curtain.

In an alternative embodiment of the invention, the method of manufacturing an airbag includes forming a one-piece woven bag comprising an upper layer, a lower layer, and a joining edge that joins the upper layer to the lower layer, cutting the one-piece woven bag through at least one of the upper and lower layers to define at least one hole in the upper layer or at least one hole in the lower layer, turning the one-piece woven bag inside out through the at least one hole in the upper or lower layers, and closing the cut portion by attaching a patch to cover the at least one hole. The upper and lower layers have a coating associated with at least one side thereof.

The method may also include cutting a cut portion along the joining edge, said cut portion being substantially aligned with the at least one hole in the at least one of the upper and lower layers. The cut portion is configured and dimensioned to receive a tool for attaching the patch. The at least one hole may be cut through both the upper and lower layers to define a through-hole through the bag. The patch may be attached to each of the upper and lower layers to close the through-hole.

In one embodiment of the method, two holes may be cut through both the upper and lower layers to define two through-holes through the bag. The two cut portions are cut along the joining edge, each of which is aligned with one of the through-holes. The method may also include cutting the one-piece woven bag along a portion of the joining edge to define an inhalator opening for connection with an inhalation device.

In another embodiment of the method, the method includes forming a loop of material, positioning the loop of material inside the airbag between the upper and lower layers between the hole in the upper layer and the hole in the lower layer, positioning the upper patch on the upper layer over the upper layer cut portion and attaching the upper patch through the upper patch, upper layer, and loop of material, and positioning the lower patch on the lower layer over the lower layer cut portion and attaching the lower patch through the lower patch, lower layer, and loop of material. The patch may be attached to the upper layer and loop of material through one of sewing, welding, gluing, or fastening. The loop of material may serve as a tether between the upper and lower layers.

In an alternative embodiment of the method, the method may include forming a loop of material, positioning the loop of material inside the airbag adjacent the at least one hole of the upper or lower layers, positioning the patch over the at least one hole, and attaching the patch to cover the hole and to connect the loop to the upper and lower layers.

An alternative embodiment of the airbag of the invention includes a one-piece woven bag having an upper layer, a lower layer, and ajoining edge joining the upper layer to the lower layer. The joining edge is disposed inside the one-piece woven bag. A coating layer is attached to at least an interior side of the upper and lower layer. The coating layer substantially covers the entire surface area of the interior sides. At least one first opening is cut through at least one of the upper and lower layers of the one-piece woven bag and at least one second opening is disposed along a portion of the joining edge of the one-piece woven bag. The second opening is for association with an inflator mechanism. At least one patch is positioned to cover the at least one opening to close the opening.

The at least one first opening may include a hole cut through both the upper and lower layers to define at least one through-hole. A patch is utilized to cover both the first opening in the upper layer and the first opening in the lower layer. The airbag may also include at least one cut portion that is cut along the joining edge. This cut portion is configured and dimensioned to receive a tool and is substantially aligned with the at least one through-hole. In one embodiment, a plurality of through-holes are provided and a plurality of patches are utilized to cover the holes on the upper and lower layers. A cut portion may be associated with each through-hole. A loop of material may be positioned between each through-hole.

The airbag may also include a seam sewn through the upper layer patch, the upper layer. The loop of material is utilized to close the at least one hole in the upper layer. A seam may also be sewn through the lower layer patch, the lower layer, and the loop of material to close the hole in the lower layer. The loop of material serves to connect the upper layer to the lower layer in the form of a tether.

Rather than including two holes, one through each of the upper and lower layers, the invention may include one hole in either of the upper or lower layers. With the hole being patched utilizing a single patch.

### BRIEF DESCRIPTION OF THE DRAWINGS

Preferred features of the present invention are disclosed in the accompanying drawings, wherein identical reference characters denote like elements throughout the several views, and wherein:

FIG. 1 is a schematic representation of part of the method of manufacturing an airbag of the invention;

FIG. 2 is a side view of an airbag that has been manufactured according to the method of the invention, with the joining edge of the airbag on the exterior thereof;

FIG. 3 is a cross-sectional view of the airbag of FIG. 2, taken at line 3-3 of FIG. 2;

FIG. 4 is a cross-sectional view of the airbag of FIG. 2, taken at line 4-4 of FIG. 2;

FIG. 5 is a side view of the airbag of FIG. 2 shown after the airbag has been turned inside out so that the joining edge is positioned inside the airbag, with baffles sewn into the side of the airbag;

FIG. 6 is a cross-sectional view of the airbag of FIG. 5, taken at line 6-6 of FIG. 5;

FIG. 7 is a cross-sectional view of the airbag of FIG. 5, taken at line 7-7 of FIG. 5;

FIG. 8 is a side view of the airbag of FIG. 5 showing the cut portion of the bag in a folded over position, with fasteners installed along the folded over portion and alternative baffles formed in the side of the airbag;

FIG. 9 is a cross-sectional view of the airbag of FIG. 5, showing tethers sewn inside the airbag;

FIG. 10 is an alternative embodiment of the airbag of the invention, showing the cut portion on the side of the airbag, with baffles formed in the side of the airbag;

FIG. 11 is a schematic of the interior of a vehicle showing the airbag of the invention installed on the driver's side of the vehicle;

FIG. 12 is a side view of an alternative embodiment of the airbag of the present invention, showing a hole cut in the side of the upper and lower layers of the bag, and smaller cut portions cut along the joining edge;

FIG. 13 is a side view of the airbag shown in FIG. 12 after the airbag has been turned inside out through the hole in the side of the bag and the hole has been patched; and

FIG. 14 is a partial cross-sectional view of the patched hole of FIG. 13, also shown as including a tether device.

### DETAILED DESCRIPTION OF THE INVENTIONS

The present invention relates to an airbag and a method of manufacturing an airbag. The invention is believed to be suitable for a wide variety of applications, including those in the automotive, aircraft, and other industries. The present invention is particularly suited for a rollover airbag curtain, which is capable of maintaining its filled state for approximately seven or more seconds upon deployment. For the sake of simplicity, the following description will focus on the use of the invention as an airbag curtain in the automotive industry, keeping in mind that a variety of applications are anticipated to derive a benefit from the invention.

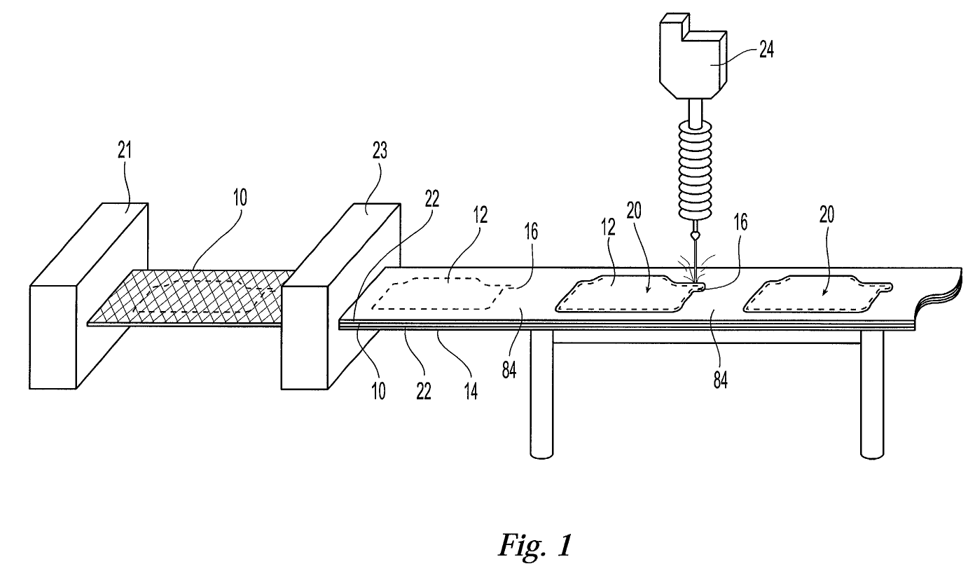

Referring to FIG. 1, the method according to the invention includes forming a sheet of material 10, such as woven fabric, comprising an upper layer 12, a lower layer 14, and a joining edge 16. The upper layer 12 and lower layer 14 are woven into the sheet 10 and are joined together around their peripheries by the joining edge 16. The joining edge 16 covers the remainder of the sheet of material 10, such that the sheet 10 is joined into a single layer of woven yarns except for the upper 12 and lower layers 14. The upper 12 and lower 14 layers are preferably shaped in the form of an airbag, such as an airbag curtain 18.

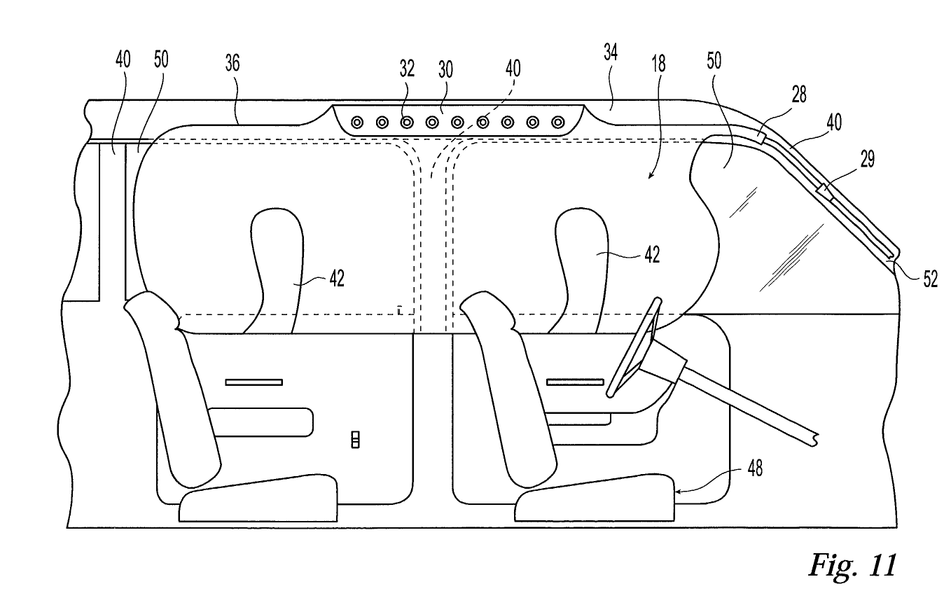

The sheet of material 10 may be woven on a jacquard type weaving machine 21. A preferred weaving method includes weaving at least three sides as one sheet, including the upper layer as the first side, the lower layer as the second side, and the joining edge as the third layer. When the bag is inflated, the bag actually takes on the shape of a four sided bag, since the ends of the airbag form surfaces of their own. For instance, the airbag of Fig. 11 would include an upper layer, lower layer, and side layers which are formed when the bag is inflated.

A preferred weave for the airbag includes a 2×2 basket weave, a 3×3 basket weave, a gegenschlauch weave, or other transitional weaves, such as twills or satins. Alternatively, the sheet of material 10 or bags 20 may be woven using an electronic or computer-controlled dobby or harness regulator capable of changing from one weave pattern to another in midstream. A series of bags may be produced in different shapes and sizes to meet particular requirements for different applications. The series of single bags is preferably woven in a continuous sheet and joined on a common side by the joining edge 16. Furthermore, the sheet 10 may include two or more airbags provided across the sheet of material (not shown) in a repeating fashion. For instance, the sheet 10 may be as narrow as 20 inches for each bag, such that for three equally sized bags, the sheet is approximately 60 inches wide. Other widths may also be used based upon the application, such as a sheet that fits 30 inch wide airbags.

A preferred material for use with the method includes a wide variety of deniers from a range of about 630 to 100 denier materials. The method can be utilized in a variety of yarn technologies and, due to its nature and the nature of the system, is not limited to the existing nylon 6.6, 6, or PET technologies. The invention, combined with the proper inflation technology of “cold gas” inflation, may utilize lower cost yams which are typically not utilized in airbags of today, such as polypropylene.

After the woven sheet 10 has been formed, each side of the sheet is preferably coated or laminated with a layer of material 22 to significantly reduce the air permeability of the sheet of material. The coating may be applied using a single pass-type machine 23 with two coating heads or laminating stations, as shown in FIG. 1, or using a double-pass-type machine (not shown). The invention is not limited to a particular type of machine for manufacturing the sheet 10. All that is required is that the sheet be woven and the coating or lamination be applied to substantially the entire surface area of each side of the sheet 10. The coating 22 may be a silicone, urethane, acrylic, or adhesive among other sealing materials.

After the coating 22 is applied, the sheet of material 10 is cut into individual airbag pieces 20. The sheet 10 may be cut by utilizing a conventionally known cutting device 24. The individual airbag pieces are preferably cut so that the upper 12 and lower layers 14 are joining substantially around their peripheries to one another via the joining edge 16. The joining edge may vary in width depending upon the particular application. The cutting device 24 may be a laser, hot knife, hot wire, or other cutting mechanism to cut the individual bags 20 out of the sheet 10. Use of a cutting mechanism that generates heat at the cutting site may result in sealing the joining edge along the cut if the amount of heat generated by the cutting mechanism is high enough to melt the woven material. This can be advantageous in that it helps to avoid unraveling of the woven airbag piece 20 after it has been cut from the sheet.

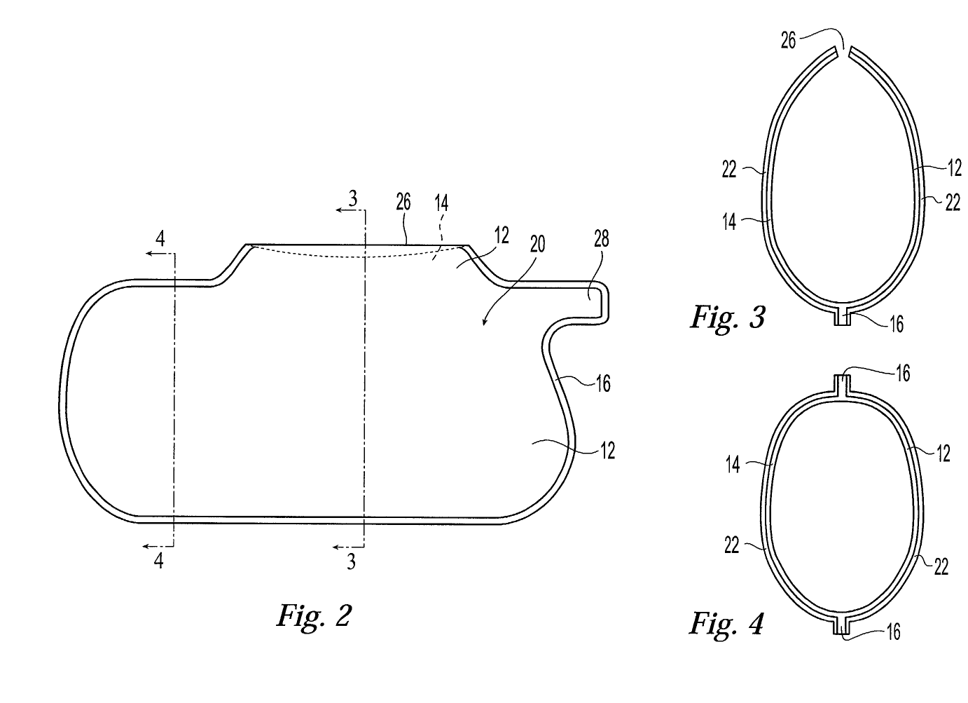

An example of an airbag piece 20 that has been cut from a sheet of material 10 according to the invention is shown in FIG. 2. As shown, the airbag 20 includes an upper coated layer 12, a lower coated layer 14, and a peripheral coated joining edge 16. The coating or lamination 22 is provided on the exterior of the airbag pieces.

It is also preferred that at least part of the airbag piece includes a cut portion 26, which does not include ajoining edge 16 so that the upper 12 and lower 14 layers are not attached to one another along the cut portion 26. This cut portion 26 may be formed when the airbag pieces 20 are cut from the sheet of material 10, such that the cutting device 24 cuts a portion of the bag 20 inside of the joining edge 16 such that the joining edge 16 does not connect the upper 12 and lower 14 layers along the cut portion 26. Alternatively, the airbag pieces 20 maybe cut from the sheet of material 10 so that the joining edge 16 is positioned around the entire periphery of the airbag piece 20. Then the cut portion 26 may be cut by separating the upper 12 and lower 14 layers from one another along the cut portion 26 by utilizing a non-sealing type of cutting mechanism, such as a scissors or die press, among other conventionally known non-sealing cutting mechanisms. After these steps in the process have been completed, the airbag pieces 20 include woven fabric upper 12 and lower 14 layers that are joined around a majority of their periphery by a joining edge 16 and each of the upper and lower layers and both sides of the joining edge 16 are coated or laminated. And the coating or lamination is positioned on the outside of the airbag pieces 20. As shown in the cross-sections of FIGS. 3 and 4, the joining edge 16 is positioned at either end of the bag 20 in the area of the bag that does not include the cut portion 26 (FIG. 4). Conversely, in FIG. 3, the bottom of the bag includes the joining edge 16, but the top of the bag includes an opening so that the upper 12 and lower 14 layers face each other in the area of the cut portion 26.

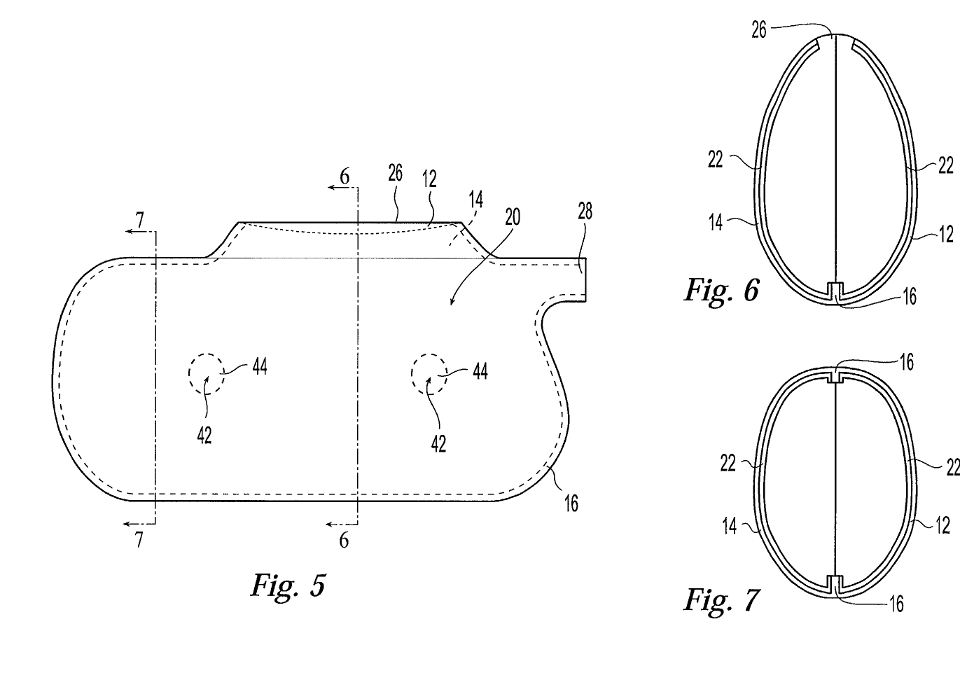

Referring to FIG. 5, once the cut portion 26 has been established, the airbag 20 can be turned inside out, or inverted or reversed, through the cut portion 26 of the bag 20 so that the coated surfaces 22 of the upper 12 and lower layers 14 and joining edge 16 are positioned inside the airbag 20, as shown in FIGS. 6 and 7. This is advantageous in that lower coating weights may be utilized in forming the bag because any air that enters the bag will push the coating 22 against the woven material of the bag 20. The joining edge 16 is preferably positioned inside the bag 20 in order to avoid contact with an occupant of a vehicle. Joining edges 16 are oftentimes abrasive and may cause injury to the occupants of the vehicle during activation of the airbag.

A second opening 28 may be formed around the joining edge 16 of the bag for association with an inflator device 29. This opening may be formed in the same way as the cut portion 26, or may be cut after the airbag piece 20 is detached from the sheet of material 10. Any number of inflator mechanisms are believed to be useful with the present invention, including sodium azide or other, more inexpensive, methods of pyrotechniques, the invention not being directed toward or limited to a particular type of inflator.

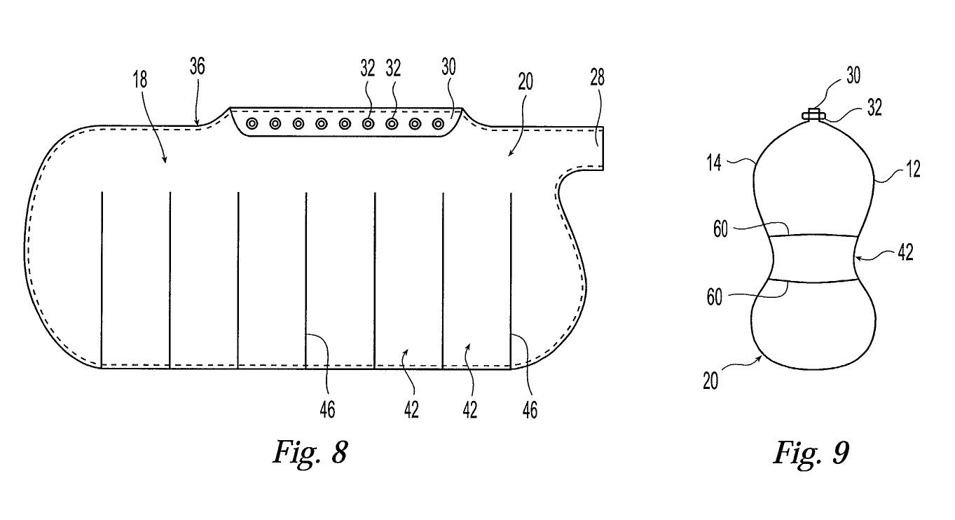

After the bag is turned inside out, the cut portion 26 is then closed by any number of methods. In closing the bag along the cut portion 26, one technique is to fold over the cut portion 26 to form multiple layers, as shown in FIG. 8. The folded over portion 30 may then be sealed shut by any number of conventional techniques, such as sewing, welding, glueing, fastening, or other known techniques. Alternatively, the bag 20 can simply be closed by placing the coated side 22 of the upper layer 12 against the coated side 22 of the lower layer 14 and closing the cut portion 26 utilizing sewing, welding, gluing, fastening, or other known closing techniques.

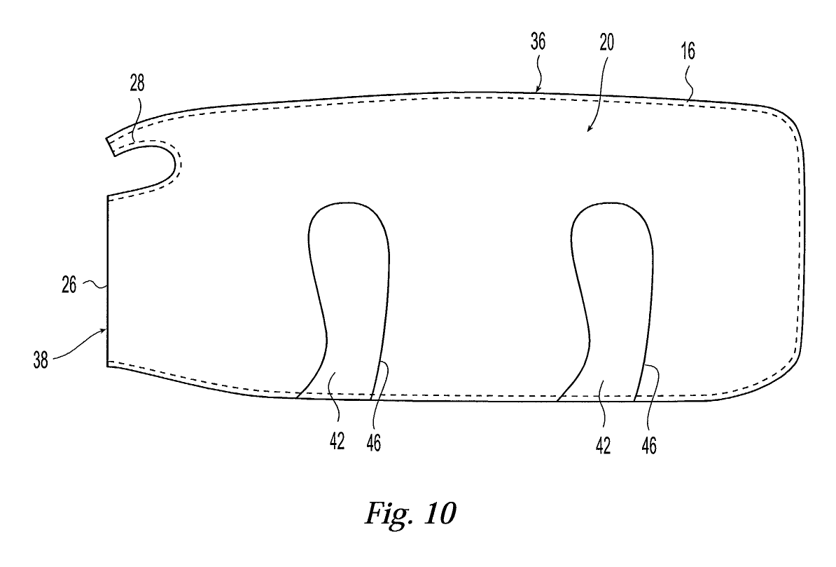

If desired, fasteners 32 may be provided along one of the edges of the bag and are useful in attaching the bag to a structure, such as the frame of an automobile. As shown in FIG. 8, fasteners, such as rivets, may be positioned along the length of the folded over portion 30 and then attached to the roof 34 of an automobile, as shown in FIG. 11. The fasteners 32 may be advantageously positioned along the folded over portion 30, which is reinforced by the multiple layers of material. Fasteners 32 may be positioned at any desirable position around the periphery of the bag 20, the position not being limited to the top edge 36 or the folded over portion. Alternatively, as shown in FIG. 10, the cut portion 26 may be positioned along the side 38 of the airbag 20 and, after closing, may be attached, for example, to a roof support 40 of a vehicle. Further still, multiple reinforced portions (not shown) such as folded over portion 30 may be positioned around the periphery of the airbag 20 for use in attaching the airbag to a structure.

Baffles 42 may be formed through the side walls of the airbag 20, if desired, to control the shape of the airbag 20. Baffles 42 may also be utilized to control the shape of various zones within the design of the airbag 20.

One technique for forming baffles involves weaving the baffles into the bag as part of the weaving process, where the woven baffles 44 are formed integrally with the woven fabric of the upper 12 and lower 14 layers to connect the layers to one another. An example of this type of baffle is shown in FIG. 5. These type of baffles create “dead zones” within the bag if the baffle is sewn through both layers of the upper and lower layers. Alternatively, constrictions may be woven between the upper and lower layers to form demarcation lines between the various baffles, so that substantially sized dead zones are not created.

Baffles 42 may also be formed by sewing seams 46 or welding 46 through the sides of the airbag 20, as shown in FIGS. 8 and 10. The sewing may be performed using a programmable machine for accuracy, such as a CNC sewing machine. Where a continuous line of sewing or welding is utilized to enclose an area on the airbag, as in FIG. 10, a “dead zone” is created in the airbag because air from the inflator mechanism cannot easily penetrate the seams 46 to fill up the inner portion of the sewn area. The sewn areas may advantageously be used as a method for controlling the deflation rate of the cushion by engineering the stitch size, number of stitches per inch, and/or size of the needle, among other techniques. For instance, should the airbag cushion have a lower demand requirement, such as a one second, or three second bag, the stitch size, number of stitches and/or size of the needle can be utilized to vary the amount of air leakage over time. If it is required that the cushion be completely air holding for seven seconds, the sewn stitches can be sprayed with a silicone, urethane, or acrylic spray and dried in a conventional air curing system, among other sealing techniques. It is estimated that the silicone proportions utilized in the present invention compared to conventional airbags that utilize a coating on the exterior of the airbag will be cut in half. The ability to produce a variety of cushions from one design, as previously discussed, will save time, labor, and inventory.

Another technique for controlling the shape of the airbag includes the use of tethers 60 to create baffles 42. Tethers 60 are woven, sewn, welded, glued, or otherwise fastened to the inside of the airbag 20. One end of each tether 70 is sewn to the upper layer 12 and the other end of each tether is sewn to the lower layer 14.

A variety of different baffles may be utilized on a particular airbag. For instance, both tethers and sewn baffles may be utilized to shape an airbag. Alternatively, pre-woven baffles may be used with welded baffles, etc.

Referring to FIG. 11, one embodiment of the airbag in the form of curtain 18 is shown installed along the driver's side 48 of a vehicle to cover at least part of the windows 50 the vehicle. The top, folded over portion 30 includes fastener rivets 32 which are utilized to connect curtain 18 to the roof frame 34 of the vehicle. Baffles 42 are formed through the side walls of the curtain 18. In addition, the second opening 28 is connected to an inflator mechanism 29, part of which is installed in the front roof support 52 of the vehicle. Although not shown, the airbag 20 may be stored in a conventional manner in storage compartments in the roof of the automobile and may be deployed when a sensor triggers the inflator mechanism 29 to inflate the airbag. The curtain 18 depicted in FIG. 11 is for exemplary purposes only, and not meant to limit the invention to a particular type of design. The attachment mechanism for attaching the airbag 20 to a vehicle may be positioned at any number of positions around the airbag. It may also be provided at multiple positions, such as both along the side and the top of the airbag, and stored in the roof and in the roof supports, for instance. The inflator mechanism may be positioned at any number of positions, including that shown in FIG. 11. The curtain may be any desired size and shape, and, alternatively, may be used to cover only a single window, or a portion of a window, etc. Thus, the invention is not to be construed as limited to the embodiment pictured in FIG. 11.

Several advantages are found in the present method. In particular, the airbag pieces 20 are easy to manufacture and may result in reduced costs by allowing for the application of lighter weight coatings or laminates 20 since the coatings or laminates 20 are positioned on the interior of the airbag 20. The woven bag of the invention is also easy to reverse by utilizing cut portion 26. The reversal area or cut portion 26 may be located along any of the sides of the bag 20 and may be utilized to provide additional strength by having a folded over area 30, which may be attached to the remainder of the airbag 20 utilizing sewing, welding, gluing, or other known attachment techniques. The reinforced section 30 is particularly advantageous along the roof mount 34, shown in FIG. 11, where stresses may be highest once the curtain 18 encounters the occupant. Another advantage of this type of system is that the manufacturer does not have to dedicate individual looms to specific car platforms. The airbag 20 as a whole can be readily made in a shell form. Once the fabric is coated and shipped to the sewing location for the cutting and reversing of the airbag, a multitude of designs and baffles can be created on a car platform basis. This generic design concept provides enormous savings in reduced inventory costs, by not requiring the supplier to change the machine for short runs. The designs can be changed on the “fly” at the cut and sew operation prior to shipment.

In an alternative embodiment, urethane sealing techniques may be utilized. One advantage of utilizing urethane is that the cut portion 26 of the bag 20 may be welded closed, rather than sewn closed. This would eliminate the need for subsequent sewing steps and the need for air holding sprays over the sewing threads. However, welding may require large amounts of urethane in certain applications to achieve adequate sheer strength and may be found to be cost prohibitive.

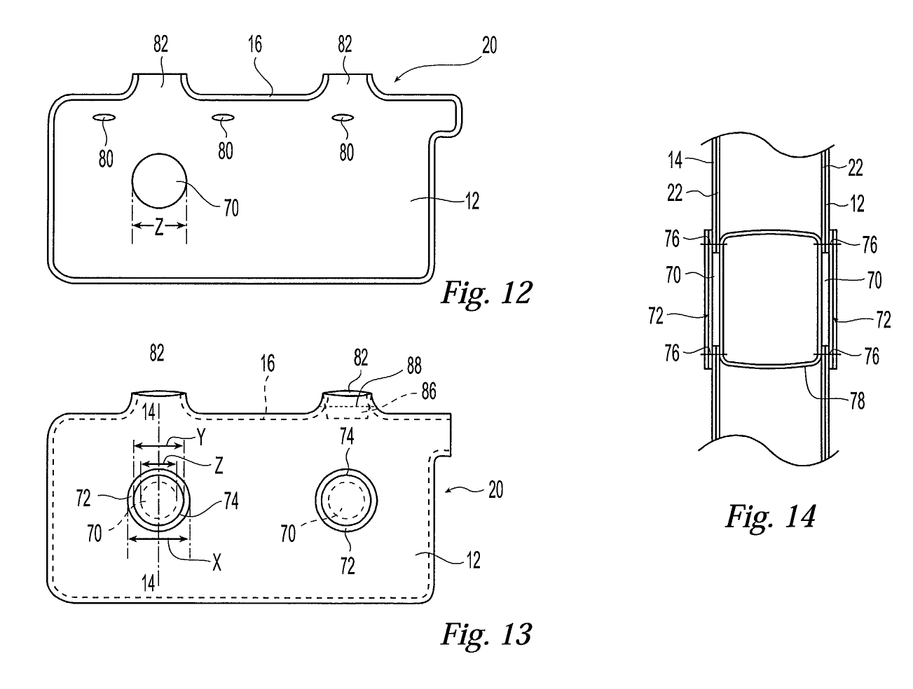

In another embodiment of the invention, shown in FIGS. 12-14, a three sided airbag cushion, as described above is formed using one-piece weaving techniques. The bag is first woven as a sheet 10 to have an upper layer 12, a lower layer 14, and ajoining edge 16. The sheet of material is coated or laminated on both sides to coat the upper and lower layers 12, 14 and the joining edge 16. The airbag 20 is then cut from the sheet of material 10 and a hole 70 is cut in the side of the airbag 20 though both layers of fabric, instead of utilizing the cut portion 26 along the joining edge 16 as with the previously discussed embodiment of FIGS. 1-11. The hole 70 may be cut from the bag 20 after the bag has been cut from the sheet of material 10, such as through die cutting. Alternatively, the hole 70 may be cut as part of the process of cutting the bag 20 from the sheet of material 10. The hole 70 is closed with a patch 72 of material after the coated fabric is reversed to the inside of the bag 20.

The patch 72 may be coated or laminated in a similar manner as the upper and lower layers 12, 14. As shown in FIG. 14, patch 70 has a coating that is positioned on the inner side of the patch 70 and positioned against the upper and lower layers 12, 14. Patches 72 are then attached over the holes 70 in order to close the holes in the upper and lower layers 12, 14. The patch 70 may be attached using techniques known by those of skill in the art, such as sewing, welding, gluing, or fastening. In the embodiment depicted in FIG. 13, a line of welding 74 or sewing 74 is shown. FIG. 14 shows the use of stitches 76 to connect the patch 72 to the upper and lower layers 12, 14.

In a preferred embodiment, cut portions 82 are provided around joining edge 16 and are substantially similar to cut portion 26, describe above. Cut portions 82 are useful in sewing patch 72 over hole 70 because they provide an opening through which a sewing machine may enter the interior of the airbag 20. For instance, the patch 72 may be sewn onto the upper and lower layers 12, 14 using a post or an arm sewing machine, which is inserted through cut portion 82. As shown in FIG. 13, more than one opening 70 may be provided. Where more than one opening 70 is provided, a cut portion may be provided for each opening 70, as shown in FIG. 13. Preferably, cut portions 82 are aligned with holes 70 in order to allow easy access by a sewing or other attachment machine. Cut portions 82 may be closed, in a manner as described above for cut portion 26, by folding over cut portion 82 to form a tab 86. Tab 86 (as depicted in phantom in FIG. 13) may be attached using any of the techniques described above for cut portion 26, such as by sewing or welding. When sewing or welding are used, among other techniques, an attachment line 88 is typically visible on the exterior of the bag 20.

In one embodiment, the patch 72 has a diameter X, the opening 70 has a diameter Z, and the connecting line 74, which may be sewing, welding, or other connection techniques, has a diameter Y. X may be 10 inches, Y may be 9 inches, and X may be 8 inches, although any combination of dimensions is feasible. The patch 72 may be attached with a sewing machine using a lock stitch.

It should be noted that while two holes 70 are shown, one hole 70 may be provided, or more than two holes may be provided. Advantageously, as discussed in greater detail below, holes 70 may be utilized, when closed, to form baffle areas. Thus, if more than two baffle areas are desired, more than two holes may be utilized. Alternatively, this hole patching technique may be utilized with other types of baffles, as described above. In addition, holes 70 are shown as being round. However, holes 70 are not required to be round and may be any shape desired. Rounded surfaces typically are desired in order to avoid high stress loads that are typically located at corners.

A window pane pattern may be sewn into the sheet of material for reference purpose in cutting the opening 70. A window pane design may be stitched in by changing the color of the thread at evenly spaced locations during the sewing process in order to create a cross-hatching effect on the fabric. This change in thread color does not affect the sewing pattern, only the outward appearance of the sheet of material. The cross-hatch or window pane pattern may then be used as a reference for cutting the openings 70 and for sewing on the patch 72.

A tether 78 may be utilized with the patch, as shown in FIG. 14. The tether preferably is a loop of material that is as wide or wider than the sewing line 74 of the patch 72, although tethers that are not as wide as hole 70 are also contemplated to be useful with this embodiment of the invention. The tether 78 is pre-sewn in the form of a loop, or can be made as a single piece using one-piece woven or other technologies. The tether 78 is positioned inside the airbag after the airbag 20 has been turned inside out so that coating layer 22 and joining edge 16 are positioned inside the airbag 20. The tether 78 may or may not be coated or laminated. The tether shown in FIG. 14 is not coated.

Advantageously, tether loop 78 maybe woven into the sheet of material 10 in the waste section 84 of the sheet (that portion that does not encompass the bag). Tether 78 may be cut from the sheet of material 10 utilizing conventionally known cutting techniques, including those discussed above. For instance, a loop of material may be formed in waste section 84 and this loop may be cut out of the sheet of material 10 using a laser. A continuous loop may be formed in this manner, without requiring that the loop be sewn independently from the manufacture of the sheet. Alternatively, the loop 78 may be formed independently from the sheet of material. Furthermore, it is not required that the loop be made of the same material as the sheet of material.

Cut portion 82 is particularly useful in sewing tether 78 in connection with patch 72, since cut portion allows for entry of an attachment device, such as a sewing or welding machine, through cut portion 82 into the interior of the bag 20. Cut portion 82 can be closed by folding over cut portion 82, as discussed above.

The airbag may include hanging clamps 80, used to hang the completed bag to a structure, such as the automobile interior shown in FIG. 11. Other attachment techniques, known to those of skill in the art, are useful with the invention, the invention not being limited to a particular attachment technique.

The patching approach of this embodiment provides two advantages over the first embodiment of the invention, described in connection with FIGS. 1-11. First, the coating can still be reversed to the inside of the bag. Second, the entire one piece woven joining edge 16 is maintained and, as a result, does not create high stress areas around the periphery of the bag 20. In addition, the replacement hole design provides the manufacturer with the opportunity to locate the reversing hole in a variety of areas, and the replacement patch, which is sewn as a baffle design, covers both sides of the bag. The drawback to this design, is that it requires a sewing operator to blindly sew the patches onto the bag, since the operator will not be able to see the stitches when he sews. A type of machine, such as a post or arm machine, may be utilized to sew on the patches.

It should be noted that the sheet of material 10 has been described as being woven as a fabric sheet. However, the use of the term fabric should not be construed to limit the invention to a particular type of material or fabric. Any type of sheet-like materials are believed to benefit from the invention, the invention not being so limited. Moreover, the term fabric, as utilized in the claims, is intended to be more encompassing than the dictionary definition of the term. The term fabric is meant to encompass any type of material that can be formed in a sheet.

While various descriptions, embodiments, and aspects of the present inventions are described above, it should be understood that the various features can be used singly or in any combination thereof. Each of the separate embodiments of the figures may be used in conjunction with or side-by-side with the other embodiments. Therefore, this invention is not to be limited to only the specifically preferred embodiments depicted herein.

Further, it should be understood that variations and modifications within the spirit and scope of the invention may occur to those skilled in the art to which the invention pertains. Accordingly, all expedient modifications readily attainable by one versed in the art from the disclosure set forth herein that are within the scope and spirit of the present invention are to be included as further embodiments of the present invention.

What is claimed is:

1. A method of manufacturing an airbag comprising:
forming a one-piece woven bag comprising an upper layer, a lower layer, and a joining edge that joins the upper layer to the lower layer, wherein the upper and lower layers have a coating associated with at least one side thereof;
cutting the one-piece woven bag along at least a portion of the joining edge to separate the upper layer from the lower layer along a cut portion;
turning the one-piece woven bag inside out through the cut portion so that the coated sides of the upper and lower layers and the joining edge are disposed inside the bag; and
closing the cut portion of the bag.

2. The method of claim 1, further comprising:
folding over the cut portion of the bag to form a folded over portion and closing the cut portion through the folded over portion.

3. The method of claim 2, wherein the closing step comprises at least one of sewing, gluing, welding, or fastening the folded over portion of the bag.

4. The method of claim 2, wherein the cut portion includes the coated side of the first layer facing the coated side of the second layer and the closing step comprises at least one of sewing, welding, gluing, or fastening the coated side of the first and second layers together.

5. The method of claim 2, further comprising attaching rivets to the folded over portion of the bag.

6. The method of claim 2, wherein the bag is substantially oblong in shape and the joining edge includes a top edge, a bottom edge, and side edges, and further comprising attaching the top edge of the bag to a portion of a vehicle.

7. The method of claim 6, wherein the folded over portion is disposed along at least the top edge.

8. The method of claim 6, wherein the folded over portion is disposed along at least one of the side edges.

9. The method of claim 7, further comprising attaching fasteners to the folded over portion and attaching the top edge, via the fasteners, to a portion of a vehicle.

10. The method of claim 1, wherein the joined edge is formed of woven yams joining the upper layer to the lower layer.

11. The method of claim 10, wherein the joined edge is formed utilizing woven yarns of at least one of a 2×2 basket weave, a 3×3 basket weave, a gegenschlauch weave, or a transitional weave.

12. The method of claim 1, wherein the woven bag is formed from yarns of at least one of nylon 6, nylon 6.6, polypropylene, or polyester.

13. The method of claim 1, further comprising connecting the first layer to the second layer at selected locations.

14. The method of claim 13, wherein the connecting step comprises sewing a plurality of seams at the selected locations.

15. The method of claim 14, further comprising coating the seams with a material to reduce the permeability of the seams.

16. The method of claim 13, wherein the connecting step comprises attaching at least one tether to the upper and lower layers at the selected locations.

17. The method of claim 1, further comprising cutting an opening in the one-piece woven bag for attachment to an inflator mechanism.

18. A method of manufacturing an airbag comprising:
forming a sheet of woven fabric comprising an upper layer of fabric, a lower layer of fabric, and a joining edge that joins the upper layer to the lower layer;
applying a coating to both exterior sides of said sheet of woven fabric to reduce the permeability of the fabric;
cutting in a desired shape through the joining edge of the sheet of woven fabric to form a one-piece woven bag so that the upper and lower layers are joined by the joining edge;
cutting the one-piece woven bag along at least a portion of the joining edge in order to separate the upper layer from the lower layer along a cut portion;
turning the one-piece woven bag inside out through the cut portion so that the coating and joining edge are disposed inside the one-piece woven bag;
closing the cut portion of the bag.

19. The method of claim 18, further comprising:
folding over the cut portion of the bag to form a folded over portion and closing the cut portion through the folded over portion by sewing through the folded over portion of the bag.

20. The method of claim 18, wherein the cut portion includes a coated side of the first layer facing a coated side of the second layer and the closing step comprises at least one of sewing, welding, gluing, or fastening the coated sides of the first and second layers together.

21. The method of claim 18, wherein the desired shape is substantially oblong and the joining edge includes a top edge, a bottom edge, and side edges, and further comprising attaching the top edge of the bag to a portion of a vehicle.

22. The method of claim 18, wherein the applying a coating step comprises applying at least one of silicone rubber, urethane, film, laminate, or adhesive to the sides of the sheet.

23. The method of claim 18, further comprising connecting the first layer to the second layer at selected locations.

24. The method of claim 23, wherein the connecting step comprises sewing a plurality of seams at the selected locations and coating the seams with a material to reduce the permeability of the seams.

25. The method of claim 23, wherein the connecting step comprises attaching at least one tether to the upper and lower layers at the selected locations.

26. An airbag comprising:
a one-piece woven bag having an upper layer, a lower layer, and a joining edge joining the upper layer to the lower layer, wherein the joining edge is disposed inside the one-piece woven bag;
a coating layer attached to at least an interior side of the upper and lower layer, wherein the coating layer substantially covers the entire surface area of the interior sides;
a first opening disposed along a portion of the joining edge of the one-piece woven bag, said first opening being closed;
at least one second opening disposed along a portion of the joining edge of the one-piece woven bag, said second opening for association with an inflator mechanism.

27. The airbag of claim 26, wherein the first opening is folded over to form a folded over portion and is closed through a treatment applied to the folded over portion.

28. The airbag of claim 27, wherein the folded over portion is one of welded, sewn, glued, or fastened closed.

29. The airbag of claim 26, wherein the first opening includes the coating of the first layer facing the coating of the second layer and the first opening is one of sewn, welded, glued, or fastened closed.

30. The airbag of claim 26, further comprising a plurality of seams sewn through the upper and lower layers of the one-piece woven bag to form baffles.

31. The airbag of claim 26, further comprising at least one tether secured between the upper and lower layers in order to join the layers inside the bag.

32. The airbag of claim 31, wherein the at least one tether includes a first end and a second end, wherein the first end is connected to the upper layer and the second end is connected to the lower layer.

33. The airbag of claim 32, wherein the first end of the tether is sewn to the upper layer and the second end of the tether is sewn to the lower layer.

34. The airbag of claim 26, further comprising at least one woven baffle section woven between the upper and lower layers of the one-piece woven bag to form baffles.

35. The airbag of claim 26, wherein the bag is a curtain.

36. A method of manufacturing an airbag comprising:
forming a one-piece woven bag comprising an upper layer, a lower layer, and a joining edge that joins the upper layer to the lower layer, wherein the upper and lower layers having a coating associated with at least one side thereof;
cutting the one-piece woven bag through at least one of the upper and lower layers to define at least one hole in the upper layer or at least one hole in the lower layer;
turning the one-piece woven bag inside out through the at least one hole in the upper or lower layers;
closing the cut portion by attaching a patch to cover the at least one hole.

37. The method of claim 36, further comprising cutting a cut portion along the joining edge, said cut portion being substantially aligned with the at least one hole in the at least one of the upper and lower layers, said cut portion being configured and dimensioned to receive a tool for attaching the patch.

38. The method of claim 37, wherein the at least one hole is cut through both the upper and lower layers to define a through-hole through the bag; and wherein a patch is attached to each of the upper and lower layers to close the through-hole.

39. The method of claim 38, wherein two holes are cut through both the upper and lower layers to define two through-holes through the bag; and wherein two cut portions are cut along the joining edge, each of which is aligned with one of said through-holes.

40. The method of claim 36, further comprising cutting the one-piece woven bag along a portion of the joining edge to define an inhalator opening for connection with an inhalation device.

41. The method of claim 37, further comprising:
forming a loop of material;
positioning the loop of material inside the airbag between the upper and lower layers between the hole in the upper layer and the hole in the lower layer;
positioning the upper patch on the upper layer over the upper layer cut portion and attaching the upper patch through the upper patch, upper layer, and loop of material; and
positioning the lower patch on the lower layer over the lower layer cut portion and attaching the lower patch through the lower patch, lower layer, and loop of material.

42. The method of claim 41, wherein the patch is attached to the upper layer and loop of material through one of sewing, welding, gluing, or fastening.

43. The method of claim 41, wherein the loop of material serves as a tether between the upper and lower layers.

44. The method of claim 36, further comprising:
forming a loop of material;
positioning the loop of material inside the airbag adjacent the at least one hole of the upper or lower layers;
positioning the patch over the at least one hole; and
attaching the patch to cover the hole and to connect the loop to the upper and lower layers.

45. An airbag comprising:
a one-piece woven bag having an upper layer, a lower layer, and a joining edge joining the upper layer to the lower layer, wherein the joining edge is disposed inside the one-piece woven bag;
a coating layer attached to at least an interior side of the upper and lower layer, wherein the coating layer substantially covers the entire surface area of the interior sides;
at least one first opening cut through at least one of the upper and lower layers of the one-piece woven bag;
at least one second opening disposed along a portion of the joining edge of the one-piece woven bag, said second opening for association with an inflator mechanism;
at least one patch covering the at least one opening to close the opening.

46. The airbag of claim 45, wherein the at least one first opening includes a hole cut through both the upper and lower layers to define at least one through-hole, and wherein a patch is utilized to cover both the first opening in the upper layer and the first opening in the lower layer; and further comprising at least one cut portion that is cut along the joining edge, said cut portion being configured and dimensioned to receive a tool and being substantially aligned with the at least one through-hole.

47. The airbag of claim 46, wherein a plurality of through-holes are provided and a plurality of patches are utilized to cover the holes on the upper and lower layers, and wherein a cut portion is associated with each through-hole.

48. The airbag of claim 45, further comprising:
a loop of material positioned between each through-hole.

49. The airbag of claim 48, further comprising a seam sewn through the upper layer patch, the upper layer, and the loop of material to close the at least one hole in the upper layer.

50. The airbag of claim 49, further comprising a seam sewn through the lower layer patch, the lower layer, and the loop of material to close the hole in the lower layer, wherein the loop of material serves to connect the upper layer to the lower layer in the form of a tether.
